(19) United States
(12) Patent Application Publication
(10) Pub. No.: US 2009/0315933 A1
(43) Pub. Date: Dec. 24, 2009

(54) INK JET RECORDING APPARATUS

(75) Inventors: Takashi Kado, Izunokuni-shi (JP); Atsushi Kubota, Sunto-gun (JP); Kazuhiko Ohtsu, Mishima-shi (JP)

Correspondence Address: TUROCY & WATSON, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 12/486,923

(22) Filed: Jun. 18, 2009

Related U.S. Application Data
(60) Provisional application No. 61/073,991, filed on Jun. 19, 2008.

(51) Int. Cl. B41J 29/38

(52) U.S. Cl. 347/13

(57) ABSTRACT

An ink jet recording apparatus includes a sub scanning driving unit which carries a recording medium in a sub scanning direction, a line-type ink jet recording head in which plural nozzles ejecting ink synchronously with the carrying of the recording medium by the sub scanning driving unit are arrayed in a main scanning direction orthogonal to the sub scanning direction, a recording medium supply unit which supplies the recording medium to the sub scanning driving unit along the sub scanning direction, a main scanning driving unit which drive-controls the ink jet recording head on the basis of an image signal and causes the plural nozzles to selectively eject ink, and a nozzle position change unit which changes position where the plural nozzles eject ink, after shifting a relative positional relation between the recording medium and the plural nozzles.

### CROSS-REFERENCE TO RELATED APPLICATION

This application claims the benefit of U.S. Provisional Application No. 61/073,991, filed on Jun. 19, 2008.

### TECHNICAL FIELD

The present invention relates to an ink jet recording apparatus in which ink ejected from a nozzle provided in an ink jet recording head is controlled.

### BACKGROUND

An ink jet recording apparatus can record a high-definition image at a high speed. The ink jet recording apparatus employs a non-impact system and therefore causes little noise. Moreover, the ink jet recording apparatus is advantageous in that it is easy to record a color image using inks of multiple colors. Therefore, the ink jet recording apparatus is popularly used for business and household applications.

The ink jet recording apparatus may have disparity among nozzles used for ejection of ink, in the case of continuously recording similar images or in the case of recording an image on target recording media of different sizes. The disparity among nozzles used for ejection of ink may cause variance in ejection characteristic due to the nozzle position and may also cause a nozzle to eject no ink.

JP-A-2004-106470 discloses a configuration in which the position of an ink jet head that is used is changed, as a configuration to improve the disparity among nozzles used for ejection of ink. The configuration disclosed in JP-A-2004-106470 restrains occurrence of ink ejection failure of nozzles even if a one-path recording system using a line-type ink jet recording head is employed.

However, in the configuration of JP-A-2004-106470, if the frequency of the use of nozzles used for ejection of ink is to be made equal over a broad range of nozzles arrayed in the ink jet recording head, the amount of movement of the ink jet recording head must be increased. As the amount of movement of the ink jet recording head is increased, the moving time of the ink jet recording head is increased. As the moving time of the ink jet recording head is increased, recording by the ink jet recording head takes longer. In the case of continuously recording similar images or in the case of recording an image on target recording media of different sizes, it is difficult to realize both reduction in the disparity among nozzles used for ejection of ink and restraint on the redundancy of time taken for recording.

It is an object of the invention to provide an ink jet recording apparatus in which the disparity among nozzles used for ejection of ink is efficiently reduced.

### SUMMARY

According to one aspect of the present invention, there is provided an ink jet recording apparatus including: a sub scanning driving unit which carries a recording medium in a sub scanning direction; a line-type ink jet recording head in which plural nozzles ejecting ink synchronously with the carrying of the recording medium by the sub scanning driving unit are arrayed in a main scanning direction orthogonal to the sub scanning direction; a recording medium supply unit which supplies the recording medium to the sub scanning driving unit along the sub scanning direction; a main scanning driving unit which drive-controls the ink jet recording head on the basis of an image signal and causes the plural nozzles to selectively eject ink; and a nozzle position change unit which changes position where the plural nozzles eject ink, after shifting a relative positional relation between the recording medium and the plural nozzles.

### DESCRIPTION OF THE DRAWINGS

FIG. 1 is a lateral sectional view of an ink jet recording apparatus according to a first embodiment.

FIG. 2 is a perspective view schematically showing the internal structure of the ink jet recording apparatus according to the first embodiment.

FIG. 3 is a block diagram showing a control system of the ink jet recording apparatus according to the first embodiment.

FIG. 4 is a flowchart showing a nozzle drying prevention routine according to the first embodiment.

FIG. 5 is a top view showing a paper supply unit which executes supply of a recording medium according to the first embodiment and a second embodiment.

FIG. 6 is a flowchart showing a nozzle drying prevention routine according to the second embodiment.

### DETAILED DESCRIPTION

Hereinafter, embodiments will be described.

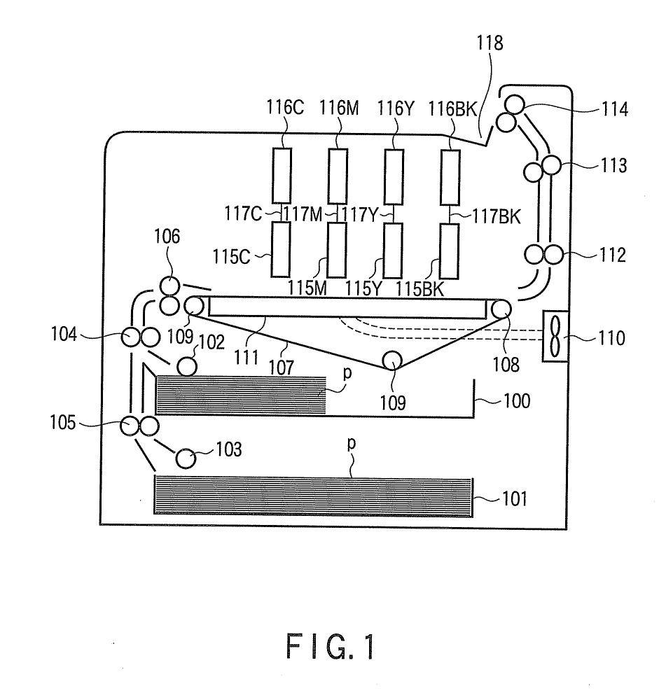

FIG. 1 is a lateral sectional view of an ink jet recording apparatus 1 according to a first embodiment. A first sheet cassette 100 and a second sheet cassette 101 hold recording media p of different sizes. A first paper supply roller 102 takes out a recording medium p corresponding to a selected recording medium size from the first sheet cassette 100 and carries the recording medium p to a first carrying roller pair 104 and a paper supply unit 106 including a registration roller pair. Similarly, a second paper supply roller 103 takes out a recording medium p corresponding to a selected recording medium size from the second sheet cassette 101 and carries the recording medium p to a second carrying roller pair 105, the first carrying roller pair 104 and the paper supply unit 106.

A carrying belt 107 is laid endlessly over a driving roller 108 and two driven rollers 109. The carrying belt 107 is given tension by the driving roller 108 and the two driven rollers 109. On the surface of the carrying belt 107, holes are opened at predetermined intervals. On the inner side of the carrying belt 107, a negative-pressure chamber 111 connected to a fan 110 is installed in order to suck the recording medium p to the carrying belt 107.

The driving roller 108 drives the carrying belt 107 to carry the recording medium p from an upstream side where the paper supply unit 106 is provided, toward a downstream side where a first carrying roller pair 112, a second carrying roller pair 113 and a third carrying roller pair 114 are provided as a paper supply unit. The carrying direction of the recording medium p is a sub scanning direction in terms of the recording operation by the ink jet recording apparatus 1.

Four lines of ink jet recording heads that eject ink to the recording medium p in accordance with print data are arranged above the carrying belt 107. From upstream, an ink jet recording head 115C which ejects cyan (C) ink, an ink jet recording head 115M which ejects magenta (M) ink, an ink jet recording head 115Y which ejects yellow (Y) ink, and an ink jet recording head 115Bk which ejects black (Bk) ink are arranged in this order.

In each of the ink jet recording heads 115C, 115M, 115Y and 115Bk, nozzles that eject ink are arranged with a predetermined resolution across the direction of the width of the recording medium p. That is, the ink jet recording heads 115C, 115M, 115Y and 115Bk are line-type heads in which plural nozzles, not shown, are arrayed in line.

The driving system of the ink jet recording heads 115C, 115M, 115Y and 115Bk is not particularly limited as long as they are line-type heads. The ink jet recording heads 115C, 115M, 115Y and 115Bk can employ any ink ejection system including a system using a thermoelectric conversion element or a system using an electrostrictive conversion element. Here, any driving source of an ink ejection system applied to the ink jet recording heads 115C, 115M, 115Y and 115Bk is called actuator.

In the ink jet recording heads 115C, 115M, 115Y and 115Bk, nozzles are arrayed in a direction orthogonal to the direction of carrying the recording medium p by the carrying belt 107. These nozzles are positioned with a prescribed space to the recording medium p situated on the carrying belt 107. Here, the nozzle arraying direction is assumed to be a main scanning direction. The ink jet recording apparatus 1 according to the first embodiment carries out recording to the recording medium p by using a line system (one-path recording system).

The ink jet recording heads 115C, 115M, 115Y and 115Bk are provided with a cyan (C) ink cartridge 116C, a magenta (M) ink cartridge 116M, a yellow (Y) ink cartridge 116Y and a black (Bk) ink cartridge 116Bk filled with ink of each color, respectively. The ink jet recording head 115C is connected with the ink cartridge 116C by a tube 117C. The ink jet recording head 115M is connected with the ink cartridge 116M by a tube 117M. The ink jet recording head 115Y is connected with the ink cartridge 116Y by a tube 117Y. The ink jet recording head 115Bk is connected with the ink cartridge 116Bk by a tube 117Bk.

The recording medium p having a full-color image formed on its entire surface by the ink jet recording heads 115C, 115M, 115Y and 115Bk is discharged to a paper discharge tray 118 by the first carrying roller pair 112, the second carrying roller pair 113 and the third carrying roller pair 114. The paper discharge tray 118 houses recording media p on which recording is finished, one after another in a stack.

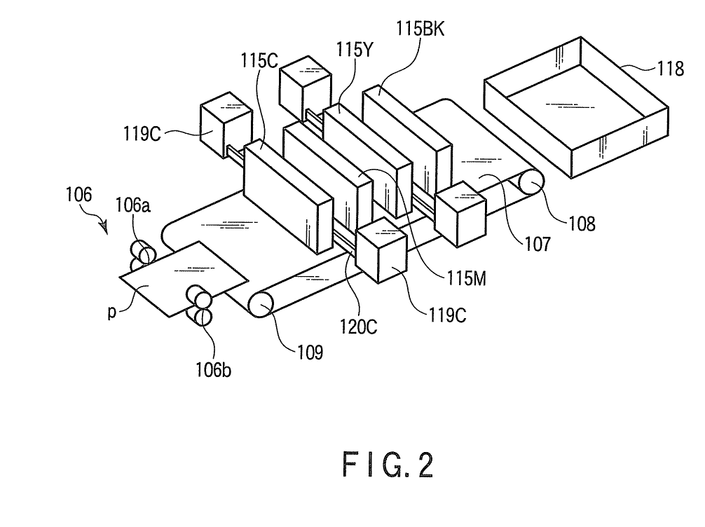

FIG. 2 is a perspective view showing the ink jet recording heads 115C, 115M, 115Y and 115Bk of the ink jet recording apparatus 1 according to the first embodiment. While the description is made with respect to the ink jet recording head 115C, the same applies to the ink jet recording heads 115M, 115Y and 115Bk.

The ink jet recording head 115C is attached to a supporting shaft 120C laid between a pair of head movement driving units 119C arranged on both sides of the main scanning direction of the carrying belt 107. The supporting shaft 120C is structured in such a manner that the ink jet recording head 115C can freely reciprocate and slide between the pair of head movement driving units 119C. The ink jet recording head 115C is reciprocated by the pair of head movement driving units 119C and a head moving motor 207, which will be described later.

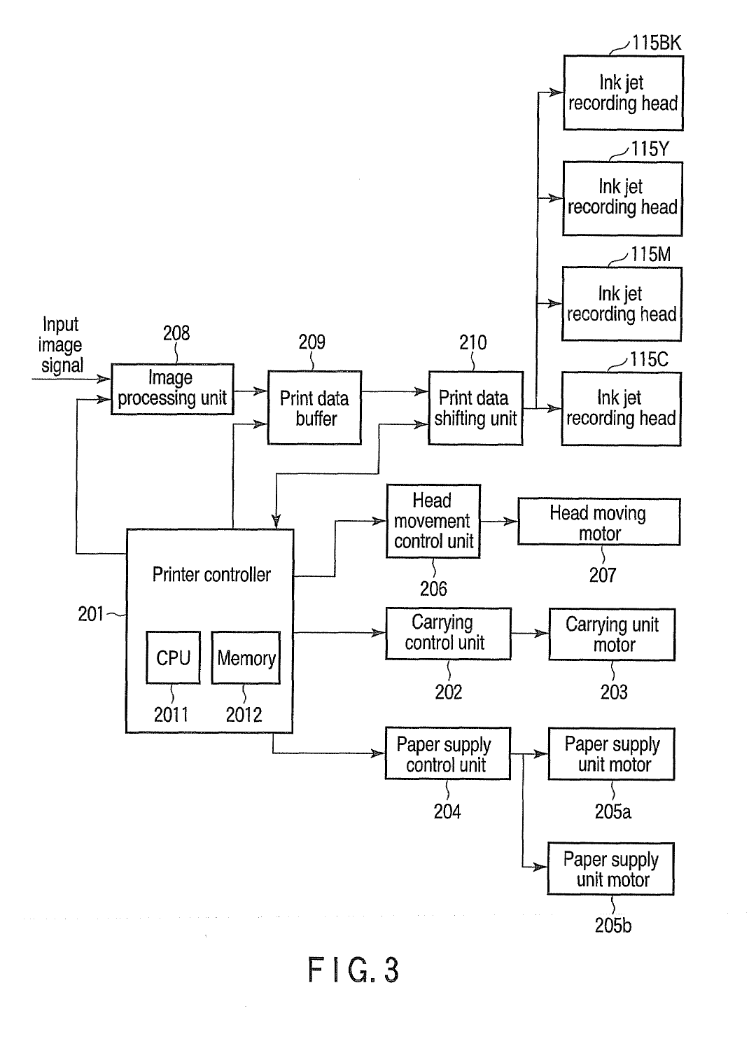

Next, image formation by the ink jet recording apparatus 1 according to the first embodiment will be described. FIG. 3 is a block diagram showing a control system of the ink jet recording apparatus 1 according to the first embodiment.

As shown in FIG. 3, the ink jet recording apparatus 1 has a printer controller 201, a carrying control unit 202, a carrying unit motor 203, a paper supply control unit 204, paper supply unit motors 205a and 205b, a head movement control unit 206, a head moving motor 207, an image processing unit 208, a print data buffer 209, and a print data shifting unit 210.

The printer controller 201 is a microcomputer having a CPU 2011 and a memory 2012. The CPU 2011 executes various operations according to programs saved in the memory 2012. The CPU 2011 outputs a control signal to each unit. In this sense, the memory 2012 serves as a storage medium which stores computer programs.

The carrying control unit 202 drive-controls the carrying unit motor 203. The carrying unit motor 203 rotates the driving roller 108. The carrying belt 107 follows the rotation of the driving roller 108 and carries the recording medium p situated on its surface from the upstream side (forward left side in FIG. 2) toward the downstream side (rear right side in FIG. 2).

That is, to execute recording by the ink jet recording apparatus 1, the carrying control unit 202 controls the movement of the recording medium p in the sub scanning direction. The carrying control unit 202 also executes discharge of the recording medium p on which recording is finished from the carrying belt 107 to the paper discharge unit 118, and operations of rollers and motors accompanying this.

The driving controller 108 is drive-controlled by the rotation of the carrying unit motor 203 driven by a control signal received from the carrying control unit 202. The driving roller 108 carries the recording medium p situated on the carrying belt 107 from the upstream side where the paper supply unit 106 is installed toward the downstream side where the paper discharge unit 118 is provided.

The paper supply control unit 204 drive-controls the paper supply unit motors 205a and 205b. The paper supply unit motors 205a and 205b rotationally drive a pair of paper supply unit driving rollers 106a and 106b constituting the paper supply unit 106, respectively. The paper supply unit driving rollers 106a and 106b supply the recording medium p toward the top side of the carrying belt 107. The paper supply control unit 204 can separately control the operation of each of the paper supply unit driving rollers 106a and 106b. Here, the case where the paper supply unit motors 205a and 205b drive the paper supply unit driving rollers 106a and 106b, respectively, is described. However, any driving system other than a system using a motor can be employed.

That is, the paper supply unit 106 can supply the recording medium p not only in the sub scanning direction but also in a different direction from the sub scanning direction. The paper supply unit 106 can carry the recording medium p to an arbitrary position in a different direction from the sub scanning direction, on the carrying belt 107. Here, the paper supply unit 106 mainly refers to a part including the paper supply unit driving rollers 106a and 106b, the paper supply control unit 204 and the paper supply unit motors 205a and 205b. The paper supply to the carrying belt 107 by the paper supply unit 106 will be described in detail later.

The paper supply unit driving rollers 106a and 106b are drive-controlled by the rotation of the paper supply unit motors 205a and 205b driven by a control signal received from the paper supply control unit 204.

The head movement control unit 206 is constructed, for example, by an integrated circuit. The head movement control unit 206 drive-controls the head moving motor 207 to move the ink jet recording head 115C in the main scanning direction. The setting of the amount of movement of the ink jet recording head 115C by the head movement control unit 206, that is, the setting of the amount of driving of the head moving motor 207, is under the control of the printer controller 201.

As for the moving direction, the ink jet recording head 115C is movable to both left and right with respect to the recording medium p on the carrying belt 107 (in the main scanning direction). The amount of movement of the ink jet recording head 115C has a limit value both in the left and right directions.

The head movement control unit 206 drive-controls the head moving motor 207 in accordance with a control signal received from the printer controller 201. The head movement control unit 206 outputs a driving signal that accelerates or decelerates the speed of the head moving motor 207 according to need.

The head moving motor 207 is provided on one of the pair of the head movement driving units 119C. The head moving motor 207 is structured, for example, to be connected to a rail, not shown. Here, the case where the head moving motor 207 drives the pair of head movement driving units 119 is described. However, any driving system other than a system using a motor can be employed.

The image processing unit 208 is constructed, for example, by an integrated circuit. The image processing unit 208 executes image processing such as gamma correction and pseudo-intermediate color correction to an inputted image signal. Then, the image processing unit 208 converts the image signal to print data suitable for printing by the ink jet recording heads 115C, 115M, 115Y and 115Bk.

The print data buffer 209 is an image memory. The print data buffer 209 temporarily stores print data generated by the image processing unit 208.

The print data shifting unit 210 is constructed, for example, by an integrated circuit. The print data shifting unit 210 drive-controls the ink jet recording heads 115C, 115M, 115Y and 115Bk on the basis of the print data stored in the print data buffer 209. The print data shifting unit 210 constitutes a driver circuit of the ink jet recording heads 115C, 115M, 115Y and 115Bk. The print data shifting unit 210 according to this embodiment is different from a driver circuit in the following features.

The print data shifting unit 210 shifts the position of nozzles that eject ink drops on the basis of the print data with respect to the ink jet recording heads 115C, 115M, 115Y and 115Bk as a whole. The print data shifting unit 210 shifts the entire recording medium p. The print data shifting unit 210 simultaneously shifts the entire ink jet recording heads 115C, 115M, 115Y and 115Bk and the entire recording medium p.

The printer controller 201, for example, serially transfers the print data stored in the print data buffer 209 to the print data shifting unit 210 on a line basis. The print data shifting unit 210 also creates the correspondence between print data and nozzles provided in the ink jet recording head 115C. The same applies to the ink jet recording heads 115M, 115Y and 115Bk.

The correspondence between print data and nozzles in this case refers to which print data of one line of print data corresponds to which nozzle provided in the ink jet recording head 115C. In other words, the correspondence between print data and nozzles refers to the correspondence between arbitrary print data and a nozzle provided in the ink jet recording head 115C that ejects ink on the basis of this arbitrary print data.

An example of the correspondence between the print data and nozzle will be described. Normally, the ink jet recording apparatus 1 employs a correspondence structure in which the first data of one line of print data corresponds to the x-th nozzle from one end and the n-th data corresponds to the (x+n)th nozzle from the one end. Therefore, in the ink jet recording head 115C, ink is usually ejected from the n-th nozzle from the one end according to the (x+n)th data.

The print data shifting unit 210 functions to properly change the correspondence rule between the print data and nozzle. That is, the print data shifting unit 210 changes the nozzle corresponding to the n-th print data, of one line of print data, to the (x+n+m)th nozzle from the one end.

Here, various techniques are realized as techniques for the print data shifting unit 210 to change the nozzle corresponding to the n-th print data, of one line of print data, to the (x+n+m)th nozzle from the one end.

As an example of the nozzle position change by the print data shifting unit 210, a technique of changing a register that registers print data will be described.

That is, as an example, the driver circuit of the ink jet recording head 115C provided in the print data shifting unit 210 registers and latches print data serially transferred on a line basis from the print data buffer 209, that is, binary data, in order of registers provided to correspond to each nozzle. This binary data is data that designates presence or absence of ink ejection by the ink jet recording head 115C.

The print data shifting unit 210 releases the latch of the register in accordance with a trigger. In the ink jet recording head 115C, the actuator that corresponds to the nozzle corresponding to the register in which print data designating ink ejection is registered is driven. In accordance with the driving of the actuator, ink is ejected from the nozzle provided in the ink jet recording head 115C. That is, the print data shifting unit 210 can register the n-th print data into the register corresponding to the (x+n+m)th nozzle from the one end, instead of registering the n-th print data into the register corresponding to the (x+n)th nozzle from the one end.

As another example of the nozzle position change by the print data shifting unit 210, a technique of using dummy data will be described. The print data shifting unit 210 adds a predetermined number of dummy data from the leading end of actual print data, of one line of print data transferred from the print data buffer 209. For example, if the print data shifting unit 210 changes the nozzle corresponding to the n-th print data to the (x+n+m)th nozzle from the one end, the print data shifting unit 210 adds (m−1) units of ummy data from the leading end of the actual print data, to the print data. The dummy data in this case is data that does not designate ink ejection from the nozzle provided in the ink jet recording head 115C, that is, data that does not designate driving of the actuator.

The two techniques as examples of the nozzle position change by the print data shifting unit 210 are described above. However, the nozzle position change is not limited to these two methods. While the print data shifting unit 210 is constructed by an integrated circuit, for example, a part of the print data shifting unit 210 may have a microcomputer configuration.

The nozzle position change by the print data shifting unit 210 is not limited to the processing executed singly by the print data shifting unit 210. The processing may be shared by other architectures, for example, the printer controller 201.

Additionally, though the print data shifting unit 210 has the driver circuit of the ink jet recording heads 115C, 115M, 115Y and 115Bk in the first embodiment, the configuration is not limited to this and the driver circuit of the ink jet recording heads 115C, 115M, 115Y and 115Bk may be provided separately from the print data shifting unit 210. In this case, the print data shifting unit 210 only executes the nozzle position change.

Next, the recording operation in ink jet recording apparatus 1 will be described. First, as the ink jet recording apparatus 1 receives a recording command together with an image signal from an external device, the printer controller 201 instructs the paper supply control unit 204 to start paper supply.

At this time, the printer controller 201 instructs the paper supply control unit 204 to carry out paper supply together with movement in the main scanning direction, for example, in accordance with operation history of the paper supply control unit 204 and the print data shifting unit 210 which is stored in the memory 2012 constituting the printer controller 201.

The paper supply control unit 204 causes the paper supply unit driving rollers 106a and 106b to operate by using the paper supply unit motors 205a and 205b. The paper supply unit driving rollers 106a and 106b supply the recording medium p onto the carrying belt 107.

The printer controller 201 executes recording by the ink jet recording heads 115C, 115M, 115Y and 115Bk synchronously with the carrying of the recording medium p by the carrying belt 107.

The ink jet recording heads 115C, 115M, 115Y and 115Bk selectively eject ink from specific nozzles by using the printer driver function provided in the print data shifting unit 210. The ink jet recording heads 115C, 115M, 115Y and 115Bk selectively eject ink from specific nozzles every time print data is transferred line by line from the print data buffer 209 to the print data shifting unit 210.

In the ink jet recording apparatus 1, an image is recorded onto the recording medium p by the combination of main scanning driving to drive-control the ink jet recording heads 115C, 115M, 115Y and 115Bk to selectively eject ink drops from nozzles for each line of print data on the basis of an image signal and sub scanning driving of the recording medium p by the carrying belt 107.

Next, processing to change the position of nozzles as a whole that eject ink to the recording medium p in order to prevent the nozzles in the ink jet recording heads 115C, 115M, 115Y and 115Bk from drying will be described.

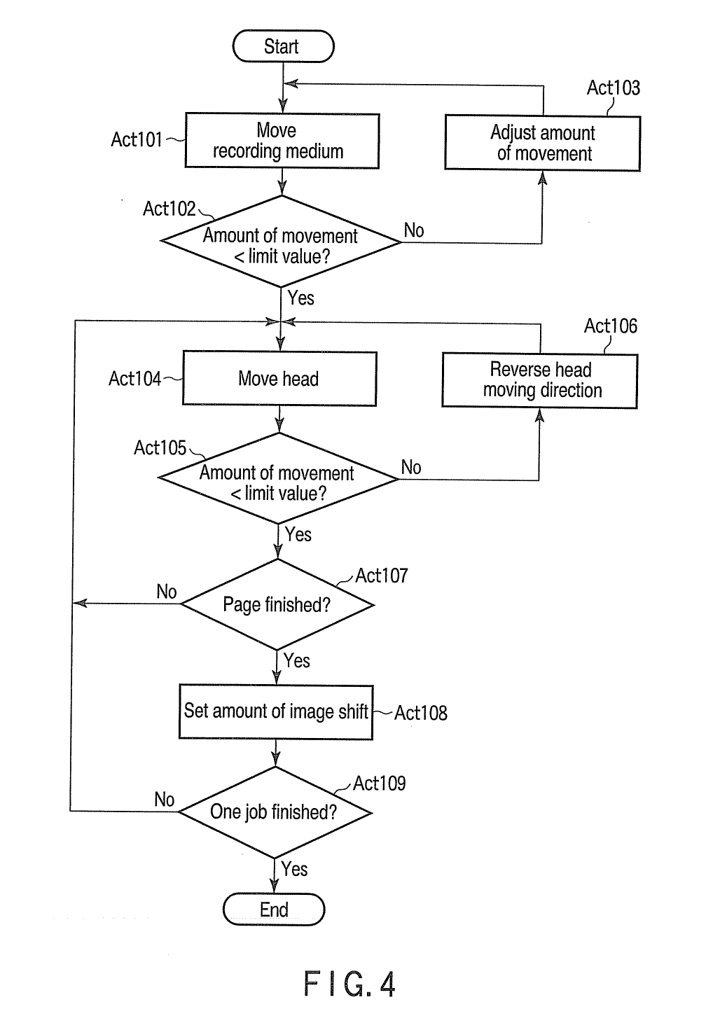

FIG. 4 is a flowchart showing a nozzle drying prevention routine according to the first embodiment. As the ink jet recording apparatus 1 receives a recording command together with an image signal from an external device, the printer controller 201 starts the processing routine shown in FIG. 4. For example, the memory 2012 stores a computer program to execute this processing routine. The CPU 2011 executes the processing routine based on this computer program. This processing routine may be stored in and executed by another computer.

The printer controller 201 executes nozzle drying prevention according to the processing routine. That is, the printer controller 201 determines the timing when nozzle drying prevention should be carried out and simply announces execution of nozzle drying prevention according to the determination. Therefore, before starting the processing routine shown in FIG. 4, the printer controller 201 executes the process and function to determine the timing when nozzle drying prevention should be carried out, as the image signal with the recording command is received from the external device.

First, the printer controller 201 executes supply of the recording medium p (Act 101). The printer controller 201 drive-controls the paper supply unit driving rollers 106a and 106b via the paper supply control unit 204. The supply of the recording medium p is the processing in which the recording medium p is moved along the main scanning direction by the paper supply unit driving rollers 106a and 106b when the recording medium p is moved onto the carrying belt 107.

The printer controller 201 determines whether the amount of movement of the recording medium p in the main scanning direction is smaller than a predetermined limit value or not (Act 102). If the amount of movement of the recording medium p is equal to or greater than the limit value (No in Act 102), the printer controller 201 adjusts the amount of movement of the recording medium p (Act 103). Repeating this operation, the printer controller 201 decides the amount of movement of the recording medium p in the main scanning direction. In this manner, the printer controller 201 executes the process and function to drive-control the paper supply unit driving rollers 106a and 106b to move the recording medium p in the main scanning direction in accordance with the determination of the timing when nozzle drying prevention should be carried out.

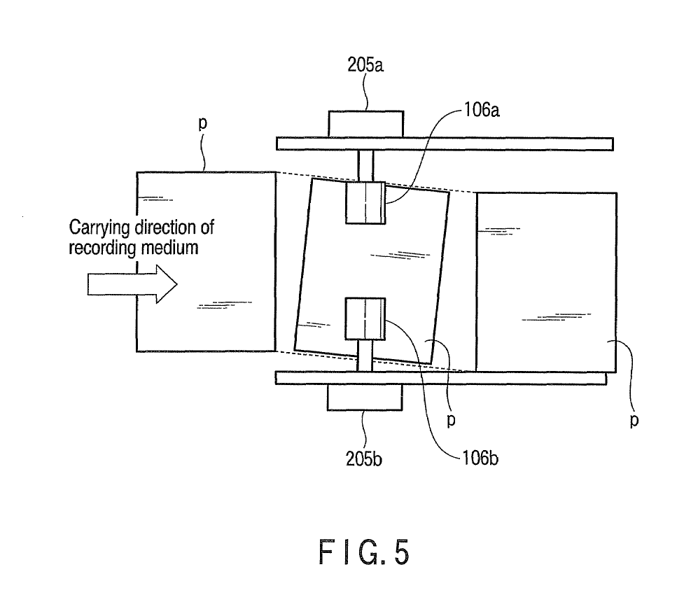

Here, the supply of the recording medium p will be described in detail with reference to FIG. 5. FIG. 5 is a view showing a schematic configuration of the vicinity of the paper supply unit 106 as viewed from above.

The paper supply unit driving rollers 106a and 106b are arranged at different positions from each other in the direction (main scanning direction) orthogonal to the carrying direction of the recording medium p (sub scanning direction). Here, the paper supply unit driving rollers 106a and 106b are at positions where they can nip the parts close to both sides of the recording medium p that is carried. The paper supply unit driving rollers 106a and 106b can be separately rotationally driven by the paper supply unit motors 205a and 205b.

The paper supply unit driving rollers 106a and 106b are configured to be rotationally driven about the same rotation axis orthogonal to the carrying direction of the recording medium p. The printer controller 201 executes the process and function to separately drive the paper supply unit driving rollers 106a and 106b via the paper supply control unit 204 and thereby move the recording medium p in the main scanning direction.

If the amount of movement is smaller than the limit value in Act 102 (Yes in Act 102), the printer controller 201 executes head movement (Act 104). The printer controller 201 drive-controls the pair of head movement driving units 119C. The head movement is the processing in which the pair of head movement driving units 119C move the ink jet recording head 115C in the main scanning direction.

The printer controller 201 determines whether the amount of head movement of the ink jet recording head 115C is smaller than a predetermined limit value or not (Act 105). If the amount of head movement is equal to or greater than the limit value (No in Act 105), the printer controller 201 carries out setting to reverse the moving direction of the ink jet recording head 115C by the pair of head movement driving units 119C (Act 106). Thus, the moving direction of the ink jet recording head 115C is reversed.

The moving direction is, for example, the direction of the ink jet recording head 115C moving from one end of the carrying belt 107 toward the other end along the main scanning direction, or conversely, the direction from the other end toward the one end.

Here, the ink jet recording head 115C moves, for example, to the left with respect to the moving direction of the recording medium p along the sub scanning direction from the initial position (for example, the center position on the carrying belt 107 along the sub scanning direction). If the amount of head movement of the ink jet recording head 115C reaches a certain limit value, the ink jet recording head 115C moves to the right to return to the initial position. The ink jet recording head 115C repeats the movement in this moving direction.

The printer controller 201 sets the moving direction of the ink jet recording head 115C to both or one of the forward path (to the right) and the backward path (to the left) in accordance with the amount of head movement of the ink jet recording head 115C, the amount of movement of the recording medium p due to the supply of the recording medium p, and their respective limit values. The printer controller 201 decides the limit value of the head movement of the ink jet recording head 115C in accordance with the amount of movement of the recording medium p due to the supply of the recording medium p. The printer controller 201 decides the amount of movement and the moving direction of the ink jet recording head 115C in the main scanning direction in accordance with the decision of the limit value of the head movement of the ink jet recording head 115C. In this manner, the printer controller 201 executes the process and function to drive-control the pair of head movement driving units 119C to move the ink jet recording head 115C in the main scanning direction in accordance with the determination of the timing when nozzle drying prevention should be carried out.

If the amount of head movement is smaller than the limit value (Yes in Act 105), the printer controller 201 determines whether print data equivalent to one page of the print data developed in the print data buffer 209 is finished or not (Act 107). If print data equivalent to one page is not finished (No in Act 107), the printer controller 201 returns to Act 104 and executes the head movement. The printer controller 201 may execute the head movement for each line of print data. If print data equivalent to one page is finished (Yes in Act-107), the printer controller 201 sets the amount of image shift (Act 108). The printer controller 201 executes the head movement separately for each of the ink jet recording heads 115C, 115M, 115Y and 115Bk.

That is, the printer controller 201 executes the nozzle position change to set the amount of shift of an image shifted by the print data shifting unit 210, that is, the number of change pitches for the nozzle position where ink is ejected from the ink jet recording head 115C. By the nozzle position change, the nozzle position where the ink jet recording head 115C ejects ink is shifted in terms of the entire ink jet recording head 115C.

The number of changed pitches set by the printer controller 201 corresponds to the amount of head movement of the ink jet recording head 115C executed in the above Act 104. That is, if the space between nozzles provided in the ink jet recording head 115C is 1 pitch and the amount of head movement is −1 pitch in a predetermined direction, the printer controller 201 sets the amount of image shift to a value shifted by 1 pitch in a predetermined direction. Similarly, if the amount of head movement is 1 pitch in a predetermined direction, the printer controller 201 sets the amount of image shift to a value shifted by −1 pitch.

Therefore, if the ink jet recording head 115C is moved to the left, the printer controller 201 set the image shift at a value shifted to the right. Similarly, if the ink jet recording head 115C is moved to the right, the printer controller 201 sets the image shift to a value shifted to the left. Since the space between nozzles provided in the ink jet recording head 115C is 1 pitch, the amount of image shift always has an integer value. However, the amount of head movement does not necessarily have an integer value.

If the amount of head movement does not have an integer value, it is desirable that the amount of image shift set by the printer controller 201 has a value approximate to the amount of head movement. For example, if the amount of head movement is −0.3 pitches in a predetermined direction, the printer controller 201 sets the amount of image shift to 0 pitch. If the amount of head movement is −0.7 pitches in a predetermined direction, the printer controller 201 sets the amount of image shift to 1 pitch in a predetermined direction. If the amount of head movement is −2.3 pitches in a predetermined direction, the printer controller 201 sets the amount of image shift to 2 pitches in a predetermined direction. If the amount of head movement is −2.7 pitches in a predetermined direction, the printer controller 201 sets the amount of image shift to 3 pitches in a predetermined direction.

Moreover, the printer controller 201 sets the amount of image shift to a value taking into consideration the amount of movement of the recording medium p due to the supply of the recording medium p. That is, the amount of image shift is the amount of relative positional movement between the recording medium p and the ink jet recording head 115C.

Furthermore, it is desirable that the printer controller 201 sets the amount of image shift with reference to the history of the amount of head movement. For example, if the amount of head movement for the first page is −0.5 pitches in a predetermined direction and the amount of head movement for the second page is −0.5 pitches in a predetermined direction, the printer controller 201 sets the amount of image shift to 0 pitch (Act 108) after the first page is finished (Yes in Act 107). The printer controller 201 sets the amount of image shift to 1 pitch in a predetermined direction after the second page is finished (Yes in Act 107). That is, the printer controller 201 determines that the amount of head movement for the combination of the first page and the second page is −1 pitch in a predetermined direction, and therefore sets the amount of image shift after the end of the second page to 1 pitch in a predetermined direction. Thus, the printer controller 201 can effectively shift the position of nozzles provided in the ink jet recording head 115C.

The printer controller 201 executes the process and function to determine the pitch corresponding to the amount of movement of the ink jet recording head 115C. As the printer controller 201 sets the amount of image shift in Act 108, the printer controller 201 determines whether recording of an image (one job) based on an image signal transmitted from outside is finished or not (Act 109). If the one job is not finished (No in Act 109), the printer controller 201 returns to Act 104. If the one job is finished (Yes in Act 109), the printer controller 201 ends movement control of the ink jet recording head 115C.

In the first embodiment, the printer controller 201 controls the movement of the ink jet recording head 115C and the recording medium p. However, the printer controller 201 may control the movement of the ink jet recording head 115C alone by omitting the movement control of the recording medium p in Act 101 to Act 103.

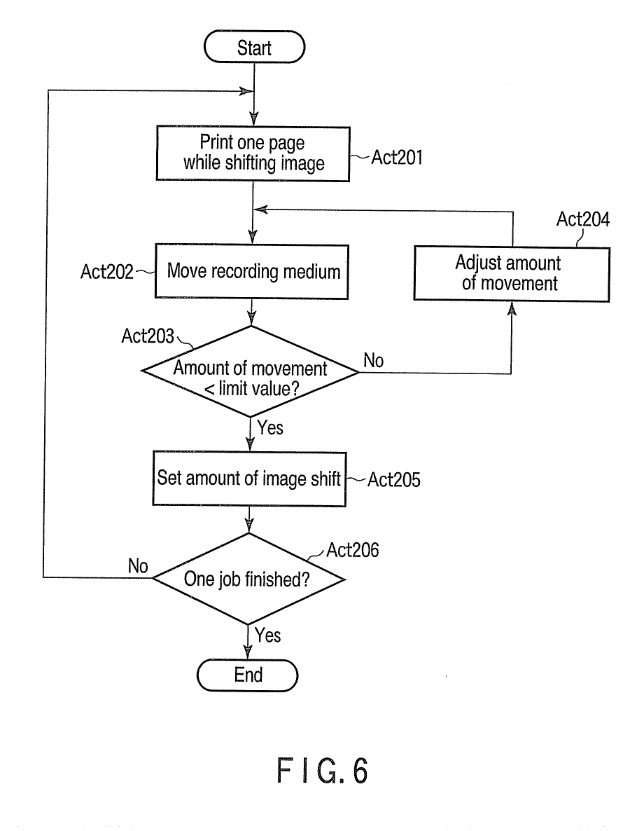

FIG. 6 is a flowchart showing a nozzle drying prevention routine according to a second embodiment. The processing routine according to the second embodiment is different from the processing routine according to the first embodiment in that the printer controller 201 does not execute head movement during the execution of recording along the main scanning direction by the ink jet recording head 115C and carrying of the recording medium p along the sub scanning direction by the carrying belt 107. The second embodiment is similar to that first embodiment in the execution of the processing routine by the printer controller 201 on the basis of the computer program stored in an arbitrary position, and in the execution of the process and function to determine the timing when nozzle drying prevention should be carried out in accordance with the reception of an image processing signal together with a recording command from an external device before the startup of the processing routine shown in FIG. 6.

First, the printer controller 201 stands by for the end of printing for one page in one job (Act 201). As printing for one page in one job is finished, the printer controller 201 executes supply of the recording medium p (Act 202). The printer controller 201 drive-controls the paper supply unit driving rollers 106a and 106b via the paper supply control unit 204. The supply of the recording medium p is the processing in which movement is made along the main scanning direction when the paper supply unit driving rollers 106a and 106b move the recording medium p onto the carrying belt 107.

After the printer controller 201 executes the supply of the recording medium p accompanying the movement in the main scanning direction in Act 202, the printer controller 201 determines whether the amount of movement of the recording medium p in the main scanning direction is smaller than a predetermined limit value or not (Act 203). If the amount of movement of the recording medium p is equal to or greater than the limit value (No in Act 203), the printer controller 201 adjusts the amount of movement of the recording medium p (Act 204). Repeating this operation, the printer controller 201 decides the amount of movement of the recording medium p in the main scanning direction.

Here, the paper supply unit driving rollers 106a and 106b move the recording medium p, for example to the left with respect to the moving direction of the recording medium p along the sub scanning direction from the initial position (for example, a position where the center position on the carrying belt 107 along the sub scanning direction coincides with the axis of the recording medium p). If the amount of movement of the recording medium p reaches a certain limit value, the paper supply unit driving rollers 106a and 106b move the recording medium p to the right in order to return to the initial position. The paper supply unit driving rollers 106a and 106b repeat the movement in this moving direction.

In this manner, the printer controller 201 executes the process and function of supplying the recording medium p in which the paper supply unit driving rollers 106a and 106b are drive-controlled to move the recording medium p in the direction of arraying of the nozzles in the ink jet recording head 115C in accordance with the determination of the timing when nozzle drying prevention should be carried out.

The supply of the recording medium p is carried out by the execution of the process and function to separately drive each of the paper supply unit driving rollers 106a and 106b via the paper supply control unit 204 by the printer controller 201 and thus move the recording medium p in the main scanning direction, as in the description of the first embodiment with reference to FIG. 5.

If the amount of head movement is smaller than the limit value (Yes in Act 203), the printer controller 201 sets the amount of image shift (Act 205). That is, the printer controller 201 executes the nozzle position change to set the amount of shift of an image shifted by the print data shifting unit 210, that is, the number of change pitches for the nozzle position where ink is ejected from the ink jet recording head 115C. By the nozzle position change, the nozzle position where the ink jet recording head 115C ejects ink is shifted in terms of the entire ink jet recording head 115C.

The number of changed pitches set by the printer controller 201 corresponds to the amount of movement of the recording medium p executed in the above Act 204. That is, if the minimum unit of the amount of movement of the recording medium p is 1 pitch and the amount of movement of the recording medium p is −1 pitch in a predetermined direction, the printer controller 201 sets the amount of image shift to a value shifted by 1 pitch in a predetermined direction. Similarly, if the amount of movement of the recording medium p is 1 pitch in a predetermined direction, the printer controller 201 sets the amount of image shift to a value shifted by −1 pitch in a predetermined direction.

Therefore, if the recording medium p is moved to the left, the printer controller 201 set the image shift at a value shifted to the right. Similarly, if the recording medium p is moved to the right, the printer controller 201 sets the image shift to a value shifted to the left. Since the minimum unit of the amount of movement of the recording medium p is 1 pitch, the amount of image shift always does not necessarily have an integer value.

Thus, if the amount of image shift does not have an integer value, it is desirable that the amount of image shift set by the printer controller 201 is at a value approximate to the nozzle space in the ink jet recording head 115C.

For example, if the amount of image shift is 0.7 pitches in a predetermined direction, the printer controller 201 sets the amount of image shift to 1 pitch. If the amount of image shift is −0.3 pitches in a predetermined direction, the printer controller 201 sets the amount of image shift to 0 pitch. That is, the printer controller 201 sets the amount of image shift by using an approximate value.

Moreover, it is desirable that the printer controller 201 sets the amount of image shift with reference to the history of the amount of movement of the recording medium p. For example, if the amount of image shift for the first page is 0.5 pitches in a predetermined direction and the amount of image shift for the second page is 0.5 pitches in a predetermined direction in accordance with the amount of movement of the recording medium p, the printer controller 201 sets the amount of image shift to 0 pitch (Act 205) after the first page is finished (Act 201). The printer controller 201 sets the amount of image shift to 1 pitch in a predetermined direction (Act 205) after the second page is finished (Act 201).

That is, the printer controller 201 determines that the amount of image shift corresponding to the amount of movement of the recording medium p for the combination of the first page and the second page is 1 pitch in a predetermined direction, and therefore sets the amount of image shift after the end of the second page to 1 pitch in a predetermined direction. Thus, the printer controller 201 can effectively shift the position of nozzles provided in the ink jet recording head 115C.

The printer controller 201 executes the process and function to determine the pitch corresponding to the amount of movement of the recording medium p. As the printer controller 201 sets the amount of image shift in Act 205, the printer controller 201 determines whether recording of an image (one job) based on an image signal transmitted from outside is finished or not (Act 206). If the one job is not finished (No in Act 206), the printer controller 201 returns to Act 201. If the one job is finished (Yes in Act 206), the printer controller 201 ends movement control of the recording medium p.

In the nozzle drying prevention according to the second embodiment, the supply of the recording medium p is executed in Act 202 and the setting of the amount of image shift is executed in Act 205. After that, recording to the recording medium p by the ink jet recording heads 115C, 115M, 115Y and 115Bk is executed. Therefore, according to the second embodiment, the printing position does not shift during the printing to the recording medium p by the ink jet recording heads 115C, 115M, 115Y and 115Bk.

The nozzle drying prevention according to the second embodiment is different from that of the first embodiment in this point. Thus, the nozzle drying prevention according to the second embodiment enables maintenance of high print quality.

Particularly if the ink jet recording apparatus 1 prints ruled lines or the like onto the recording medium p, even a slight shift in the sub scanning direction of the ruled lines printed on the recording medium p is easily visually recognized. If the printer controller 201 executes the nozzle drying prevention routine according to the second embodiment, occurrence of a shift due to the operation of each unit in the nozzle drying prevention according to the second embodiment can be eliminated.

As described above, the printer controller 201 sets the amount of image shift in accordance with the amount of movement of the recording medium p. It is desirable that the ratio of the amount of movement of the recording medium p to the amount of image shift is the relation of −1 pitch to 1 pitch, or 1 pitch to −1 pitch. If such a relation is assumed, the print position does not shift at all between pages.

The reason for the absence of shift is that, for example, if the recording medium p moves by 1 pitch in a direction from one end toward the other end of the carrying belt 107 along the main scanning direction, the position of ink ejecting nozzles provided in the ink jet recording head 115C is shifted in the reverse direction by 1 pitch with respect to all the nozzles. That is, in printing on each page, the relative positional relation between the recording medium p and the position of the ink ejecting nozzles is constant.

According to the first embodiment and the second embodiment, during printing of one job, the position of ink ejecting nozzles is gradually shifted with respect to the entire ink jet recording head 115C. The number of nozzles that do not eject ink, of the nozzles provided in the ink jet recording head 115C, is decreased. Therefore, ink ejection failure in the nozzles of the ink jet recording head 115C becomes less likely to occur.

According to the first embodiment and the second embodiment, in the case of printing an image on recording media p of different sizes or in the case of continuously printing similar images, the disparity among nozzles used in the ink jet recording head 115C is reduced and the operation can be carried out at a high speed. Thus, the frequency in using the nozzles can be made even as a whole.

In the first embodiment and the second embodiment, the ink jet recording apparatus 1 using the four ink jet recording heads 115C, 115M, 115Y and 115Bk to form a color image is described. However, the ink jet recording apparatus 1 using only the ink jet recording head 115Bk to form a monochrome image may also be used. The ink jet recording apparatus 1 in which an additional ink jet recording head for ejecting reaction solution to condense ink is provided upstream from the ink jet recording head 115C may also be employed.

What is claimed is:

1. An ink jet recording apparatus comprising:
a sub scanning driving unit which carries a recording medium in a sub scanning direction;
a line-type ink jet recording head in which plural nozzles ejecting ink synchronously with the carrying of the recording medium by the sub scanning driving unit are arrayed in a main scanning direction orthogonal to the sub scanning direction;
a recording medium supply unit which supplies the recording medium to the sub scanning driving unit along the sub scanning direction;
a main scanning driving unit which drive-controls the ink jet recording head on the basis of an image signal and causes the plural nozzles to selectively eject ink; and
a nozzle position change unit which changes position where the plural nozzles eject ink, after shifting a relative positional relation between the recording medium and the plural nozzles.

2. The apparatus of claim 1, comprising a head movement driving unit which reciprocates the ink jet recording head in the main scanning direction.

3. The apparatus of claim 2, wherein the nozzle position change unit changes the position where the plural nozzles eject ink in accordance with an amount of movement by the head movement driving unit.

4. The apparatus of claim 1, wherein the recording medium supply unit moves the recording medium in the main scanning direction before supplying the recording medium to the sub scanning driving unit.

5. The apparatus of claim 4, wherein the nozzle position change unit changes the position where the plural nozzles eject ink in accordance with an amount of movement of the recording medium by the recording medium supply unit.

6. The apparatus of claim 3, wherein the recording medium supply unit moves the recording medium in the main scanning direction before supplying the recording medium to the sub scanning driving unit.

7. The apparatus of claim 6, wherein the nozzle position change unit changes the position where the plural nozzles eject ink in accordance with an amount of movement of the ink jet recording head by the head movement driving unit and an amount of movement of the recording medium by the recording medium supply unit.

8. The apparatus of claim 5, wherein the main scanning driving unit reads out print data corresponding to the image signal from a memory on a line basis.

9. The apparatus of claim 7, wherein the main scanning driving unit reads out print data corresponding to the image signal from a memory on a line basis.

10. The apparatus of claim 5, wherein the recording medium supply unit moves the ink jet recording head every time one page of one job is finished.

11. The apparatus of claim 7, wherein every time one page of one job is finished, the head movement driving unit moves the ink jet recording head and the recording medium supply unit moves the recording medium.

12. The apparatus of claim 1, wherein if the ink jet recording head is provided in a plural number, the nozzle position change unit changes the position where the plural nozzles eject ink for each of the ink jet recording heads.

13. The apparatus of claim 5, wherein the nozzle position change unit changes the position where the plural nozzles eject ink, by the same amount as the amount of movement of the recording medium in a direction opposite to a moving direction of the recording medium.

14. The apparatus of claim 7, wherein the nozzle position change unit changes the position where the plural nozzles eject ink, by a relative amount of movement based on movement of the ink jet recording head and the recording medium in a direction opposite to a relative moving direction based on movement of the ink jet recording head and the recording medium.

15. The apparatus of claim 1, wherein the head movement driving unit moves the ink jet recording head for each line of print data corresponding to the image signal during carrying of the recording medium by the sub scanning driving unit and during printing by the ink jet recording head.

16. The apparatus of claim 2, wherein the head movement driving unit reciprocates in accordance with a movement limit value.

17. The apparatus of claim 4, wherein the recording medium supply unit reciprocates in accordance with a movement limit value.

18. An ink jet recording method comprising:
supplying a recording medium in a sub scanning direction;
in an ink jet recording head having plural nozzles arrayed in line in a main scanning direction orthogonal to the sub scanning direction, selectively ejecting ink from the plural nozzles on the basis of an image signal synchronously with carrying of the recording medium; and
changing position where the plural nozzles eject ink, after shifting a relative positional relation between the recording medium and the plural nozzles.

19. The method of claim 18, comprising changing the position where the plural nozzles eject ink, by a relative amount of movement based on movement of the ink jet recording head and the recording medium in a direction opposite to a relative moving direction based on movement of the ink jet recording head and the recording medium.

20. An ink jet recording apparatus comprising:
means for carrying a recording medium in a sub scanning direction;
means for ejecting ink from plural nozzles are arrayed in line in a main scanning direction orthogonal to the sub scanning direction, synchronously with the carrying of the recording medium;
means for supplying the recording medium along the sub scanning direction before carrying the recording medium;
means for controlling the plural nozzles to selectively eject ink on the basis of an image signal; and
means for changing position where the plural nozzles eject ink, after shifting a relative positional relation between the recording medium and the plural nozzles.
